(19) United States
(12) Patent Application Publication
(10) Pub. No.: US 2012/0109701 A1
(43) Pub. Date: May 3, 2012

(54) Fulfillment Workflow Optimization

(75) Inventors: Stephanie Filomena Seugling, Concord, NC (US); Janet Mackey Morgan, Charlotte, NC (US); Charles Cary Hudgins, Charleston, SC (US); Edward C. Ritter, Charlotte, NC (US); Christopher E. Huntley, Huntersville, NC (US); Christine M. Fricke, Saint Augustine, FL (US); Mary K. Riley, Denver, NC (US); Anne M. Badgley, Evanston, IL (US); Trina Marie Greene, Bristow, VA (US); John Dewel Pickford, Lakeway, TX (US); Gary L. Olberding, Jacksonville, FL (US); Randal J. Bishop, Jacksonville, FL (US); John F. McGraw, Jacksonville, FL (US); Marisol Rios, Windsor, CT (US); Kristi J. Evatt, Concord, NC (US); Scott C. Arcure, Chapel Hill, NC (US); Suzette Oxendine, Virginia Beach, VA (US); Cathleen Corcoran, Natick, MA (US)

(73) Assignee: Bank of America Corporation, Charlotte, NC (US)

(21) Appl. No.: 12/917,215

(22) Filed: Nov. 1, 2010

(51) Int. Cl. G06Q 10/00; G06Q 90/00

(52) U.S. Cl. 705/7.13; 705/7.14

(57) ABSTRACT

A system and method for an optimization of fulfillment workflow is disclosed. In accordance with one embodiment of the present disclosure. In accordance with embodiments of the present disclosure, a method may include receiving a request to be fulfilled from a client. The method may also include determining one or more item attributes associated with the request. The method may additionally include generating a batch of work units related to the request based at least in part on the one or more item attributes. The method may further include selecting an agent from a plurality of agents to process the batch. Moreover, the method may include transmitting the batch to the agent.

### TECHNICAL FIELD

The present invention relates generally to workflow management, and more particularly to a fulfillment workflow optimization.

### BACKGROUND

Enterprises include multiple transaction and document management systems to support daily activities. With respect to the fulfillment of sales of financial products, sales and service representatives responsible for advising customers regarding purchases of financial products and agents responsible for performing tasks to facilitate fulfillment of such financial products may be dispersed across an enterprise and may be managed by leaders from different lines of businesses and geographic regions. Thus, coordinating and managing optimal workflow for fulfillment remains a challenge for enterprises.

### SUMMARY

In accordance with the present disclosure, the disadvantages and problems associated with prior systems and methods for fulfillment workflow have been substantially reduced or eliminated.

In accordance with embodiments of the present disclosure, an apparatus may include a network interface and a processor. The network interface may be operable to receive from a client a request to be fulfilled. The processor may be coupled to the network interface and operable to: (i) determine one or more item attributes associated with the request, (ii) generate a batch of work units related to the request based at least in part on the one or more item attributes, (iii) select an agent from a plurality of agents to process the batch, and (iv) transmit the batch to the agent.

In accordance with further embodiments of the present disclosure, a tangible computer readable medium may comprise logic. The logic may be operable, when executed on a processor, to: (i) receive a request to be fulfilled from a client, (ii) determine one or more item attributes associated with the request, (iii) generate a batch of work units related to the request based at least in part on the one or more item attributes, (iv) select an agent from a plurality of agents to process the batch, (v) transmit the batch to the agent or a series of agents.

In accordance with additional embodiments of the present disclosure, a method may include receiving a request to be fulfilled from a client. The method may also include determining one or more item attributes associated with the request. The method may additionally include generating a batch of work units related to the request based at least in part on the one or more item attributes. The method may further include selecting an agent from a plurality of agents to process the batch. Moreover, the method may include transmitting the batch to the agent or a series of agents.

Technical advantages of certain aspects of the present disclosure include optimizing fulfillment workflow via parallel processing, auto-population of data, automated imaging and indexing of documentation and decision engines. For example, methods and systems of the present disclosure may ensure that a client enters complete and accurate information for fulfillment of a request, thus potentially reducing the likelihood that an agent fulfilling such request will need to obtain more information and/or clarify information provided within the request in order to fulfill the request. As a result, particular embodiments of the present disclosure provide numerous operational benefits. Nevertheless, particular embodiments may provide some, none, all or additional technical advantages.

### BRIEF DESCRIPTION OF THE DRAWINGS

For a more complete understanding of the present invention and its advantages, reference is now made to the following description taken in conjunction with the accompanying drawings, in which:

FIG. 1 illustrates a workflow management system in accordance with particular embodiments of the present disclosure; and

FIG. 2 illustrates a flow chart illustrating an example method of a particular operation of workflow management system of FIG. 1 in accordance with particular embodiments of the present disclosure.

### DETAILED DESCRIPTION

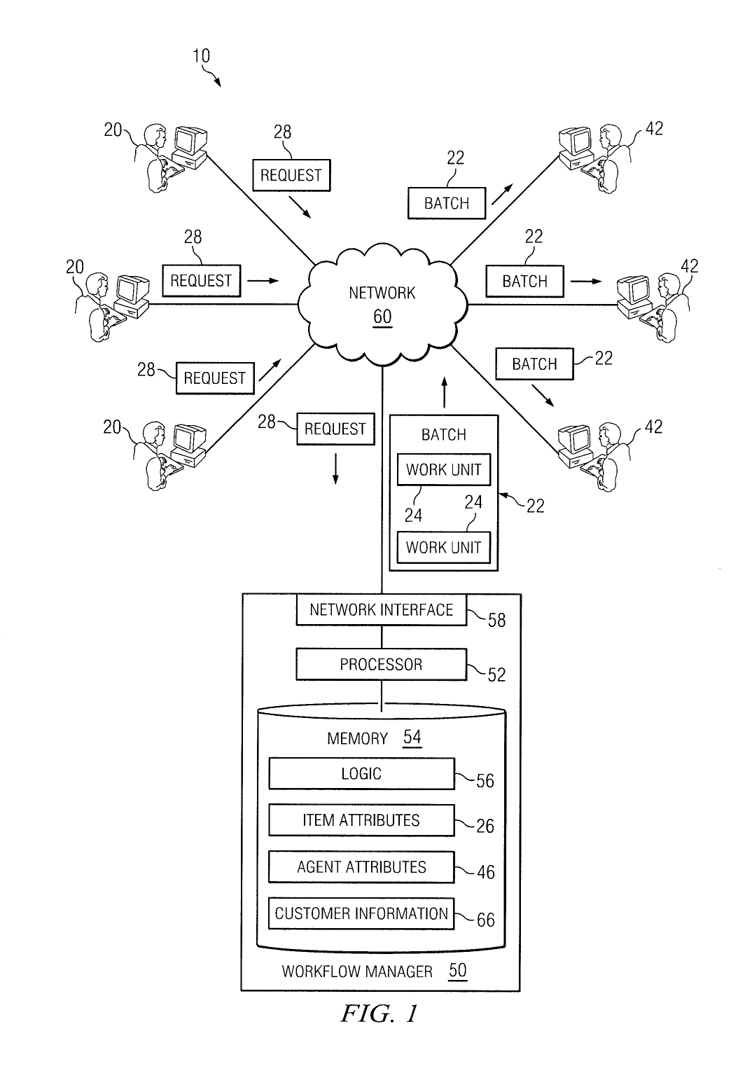

FIG. 1 illustrates a workflow management system 10 in accordance with particular embodiments of the present disclosure. System 10 may include clients 20, workflow manager 50, and agents 42. Clients 20, workflow manager 50, and agents 42 may be communicatively coupled by network 60. System 10 is generally operable to optimize fulfillment workflow in order to provide for efficient fulfillment of requests. To optimize fulfillment workflow, workflow manager 50 may receive requests 28 from clients 20, and may transmit work units 24 in batches 22 to agents 42 based on item attributes 26 associated with work units 24 and/or agent attributes 46 associated with agents 42.

Clients 20 (which may collectively be referred to as “clients 20” or individually as “client 20”) represent any person and/or device that may submit a request 28 for an item to workflow manager 50 via network 60, for example a request for acquisition of a global financial product (e.g., a request for pricing, a deposit account, a credit card, a brokerage account, a certificate of deposit, an electronic transfer, a lockbox, a stock, a bond, a financial security, a letter of credit, a line of credit, a mortgage, etc.) for fulfillment in system 10. For example, in some instances, a client 20 may include a customer or potential customer who desires to acquire a particular financial product from an enterprise. In other instances, a client 20 may include a salesperson or other representative of an enterprise who solicits a customer or potential customer of the enterprise to purchase a financial product. A client 20 may communicate with workflow manager 50 via a computer, telephone or other electronic device interfaced to network 60. For example, in instances in which client 20 is a customer or potential customer of a financial institution, client 20 may interface with workflow manager 50 via a web browser displaying the financial institution's website. As another example, in instances in which client 20 is a representative of an enterprise, client 20 may interface with workflow manager 50 via a web browser or other software configured to interact with workflow manager 50.

A request 28 represents a request to acquire an item (e.g., a financial product including one or more of a deposit account, a credit card, a brokerage account, a certificate of deposit, a stock, a bond, a financial security, a letter of credit, a line of credit, a mortgage, etc.). A request may also include associated item attributes 26. In particular embodiments, item attributes 26 may include an item type (e.g., a deposit account, a credit card, a brokerage account, a certificate of deposit, a stock, a bond, a financial security, a letter of credit, a line of credit, a mortgage, etc.), a customer name, a monetary amount associated with the item (e.g., a credit line of a particular amount), dates associated with item (e.g., deadline for issuing item, maturity dates, etc.), a customer account number, a relative priority, a skill level, and an estimated time to complete. An estimated time to complete represents an average amount of time from request to fulfillment of an item subject to a request 28. A deadline to complete represents a time to complete fulfillment of an item subject to a request 28. A deadline to complete may be expressed in absolute or relative terms. For example, item attributes 26 may indicate that a deadline to fulfill an item is a particular date. Item attributes 26 may additionally or alternatively indicate that a deadline to fulfill an item is a particular period of time (e.g., one week, two weeks, one month) from the time an agent 42 is assigned a batch 22 associated with the request 28. A skill level may represents a particular skill required to fulfill a request 28. Relative priority indicates a relative processing order in case of conflict with another request 28.

Workflow manager 50 may be configured to generate a display to and/or request information from clients 20 to facilitate completion of a request 28 by a client 20. For example, if a client 20 desires to submit a request and or supporting documentation 28 for a particular type of item, workflow manager 50 may generate a display (e.g., an electronic interview form on a display device of a computer) to client 20 wherein such display indicates information to be provided as part of the request 28 in order to fulfill the request. Such generated display may be based on item attributes 26 and/or customer information 66 residing on workflow manager 50. For example, item attributes 26 may indicate that for a particular requested item, a customer's employment information is to be provided. Accordingly, workflow manager 50 may generate a form field or other indication that employment information is to be entered as part of the request 28. As another example, customer information 66 may be utilized such that workflow manager 50 may pre-populate information to be displayed to client 20 (e.g., customer name, address, social security number and/or other profile- or account-level information may be pre-populated in an electronic form for the request 28) such that the information need not be re-entered and/or such that the information may be verified by client 20.

Workflow manager 50 may receive a completed request 28 via network 60, generate a batch 22 of work units 24 related to request 28, and select an agent 42 to process the batch 22. In particular embodiments, workflow manager 50 may generate work units 24 for a batch 22 and/or select an agent 42 for processing of the batch based on, at least in part, item attributes 26 and/or agent attributes 46.

Workflow manager 50 may include any suitable combination of hardware and/or software implemented in one or more modules to provide the described functions and operations. In some embodiments, workflow manager 50 may comprise a general-purpose personal computer (PC), a Macintosh, a workstation, a Unix-based computer, a server computer, or any suitable processing device. In some embodiments, the functions and operations described above may be performed by a pool of multiple workflow managers 50. Workflow manager 50 may include processor 52, memory 54, logic 56, and network interface 58. Workflow manager 50 may also include imaging and indexing software, as well as connections to external imaging devices, printers or fax machines.

Memory 54 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information such as batch 22, work units 24, requests 28, item attributes 26, agent attributes 46, and customer information 66. Although FIG. 1 illustrates memory 54 as internal to workflow manager 50, it is understood that memory 54 may be internal or external to workflow manger 50, depending on particular implementations. Memory 54 may be separate from or integral to other memory devices to achieve any suitable arrangement of memory devices for use in system 10.

Memory 54 is further operable to store logic 56. Logic 56 may generally comprise rules, algorithms, code, tables, and/or other suitable instructions for receiving, storing, and transmitting requests 28 and/or batches 22. Logic 56 may also additionally comprise instructions for displaying information related to a request 28 to clients 20, generating batches 22 of work units 24 related to received requests 28, selecting a particular agent 42 to process a batch 22, and/or displaying information to agents 42 related to assigned batches 22.

Memory 54 may be communicatively coupled to processor 52. Processor 52 may be generally operable to execute logic 56 to display information related to request 28 to clients 20, receive requests 28, generate batches 22 of work units 24 related to received requests 28, select a particular agent 42 to process a batch 22, transmit a batch 22 to the selected agent 42, and/or display information to agents 42 related to assigned batches 22. Processor 52 may display information to client 20, generate batches 22 of work units 24, select a particular agent 42, transmit a batch 22, and/or display information to agents 42 based on any appropriate factors, including item attributes 26, agent attributes 46, and/or customer information 66. Processor 52 comprises any suitable combination of hardware and software implemented in one or more modules to provide the described function or operation.

Network interface 58 may communicate information with network 60. For example, network interface 58 receives requests 28 from clients 20 via network 60. As another example, network interface 58 communicates batches 22 to agents 42 via network 60. Network interface 58 represents any port or connection, real or virtual, including any suitable hardware and/or software that enables workflow manager 50 to exchange information with network 60, clients 20, agents 42, and/or or other components of system 10.

A work unit 24 represents one of one or more tasks to be completed in order to issue an item (e.g., financial product) subject to a request 28. For example, in some embodiments, a work unit 24 may represent a task to obtain a credit report for a customer, verify a customer's income, establish an account, and/or any other suitable task. A batch 22 of work units 24 may be generated based on one or more item attributes 26 related to request 28. For example, item attributes 26 may include various business rules or policies associated with fulfillment of a particular item or product. Thus, based on the type of item subject to a request 28 (e.g., type of financial product desired by a customer), workflow manager 50 may generate a suitable batch 22 of work units 24 to be processed by an agent 24 in order to fulfill the request.

Similar to requests 28, a batch 22 and/or a work unit 24 may also include associated item attributes 26. In particular embodiments, item attributes for a batch 22 and/or work unit 24 may include an item type (e.g., a deposit account, a credit card, a brokerage account, a certificate of deposit, a stock, a bond, a financial security, a letter of credit, a line of credit, a mortgage, etc.), a customer name, a monetary amount associated with the item (e.g., a credit line of a particular amount), dates associated with item (e.g., deadline for issuing item, maturity dates, etc.), a customer account number, a relative priority, a skill level, and an estimated time to complete.

Agents 42 (which may collectively be referred to as “agents 42” or individually as “agent 42”) process work units 24. For purposes of this description, “processing” refers to performance, supervision, and/or delegation of tasks embodied in work units 24 in order to fulfill an item subject to a request 28. In particular embodiments, agents 42 may possess different skill types. For example, a skill type may include, for example, the speed or rate at which an agent 42 is able to complete batches, the ability of the agent to work with a particular type of batch 22 (e.g., some agents 42 may specialize in loan products while others specialize in deposit products), and/or the ability to process one or more item attributes 26 associated with a batch 22. In some embodiments, agents 42 may possess more than one skill type. In particular embodiments, an agent 42 may be associated with agent attributes 46. Agent attributes 46 may include, but are not limited to, one or more skill type(s) possessed by agent 42, an availability of agent 42, an efficiency level agent 42 possesses for a particular type of process associated with a batch 22, and/or an affinity of agent 42 to a particular customer and/or type of customer. Agent 42 may also refer to an automated, systemic interface.

Network 60 may represent any number and combination of wireline and/or wireless networks suitable for data transmission. Clients 20, agents 42, and workflow manager 50 may be communicatively coupled via one or more networks 60. Network 60 may, for example, communicate interne protocol packets, frame relay frames, asynchronous transfer mode cells, and/or other suitable information between network addresses. Network 60 may include one or more intranets, local area networks, metropolitan area networks, wide area networks, cellular networks, all or a portion of the Internet, and/or any other communication system or systems at one or more locations.

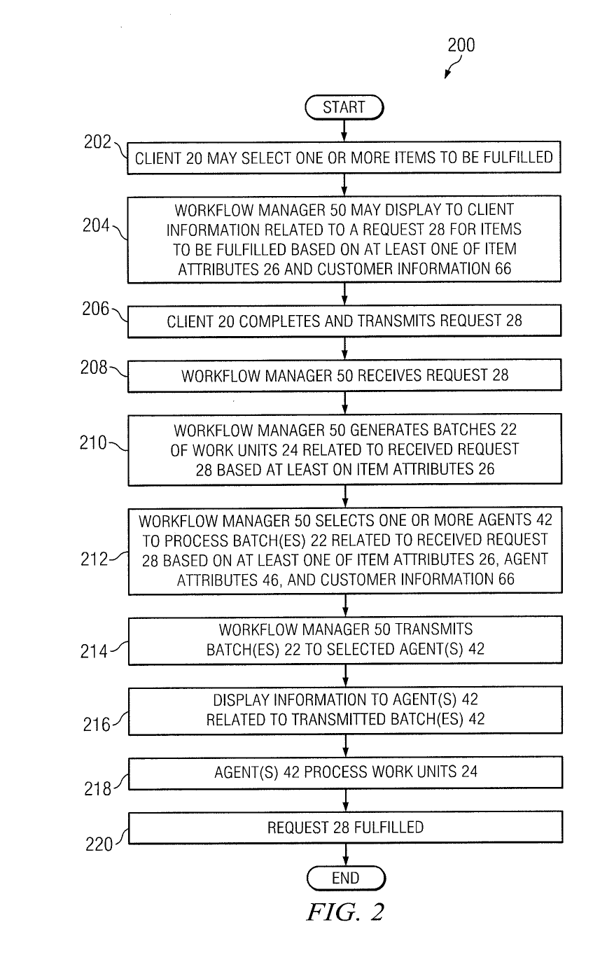

FIG. 2 illustrates a flow chart illustrating an example method 200 of a particular operation of workflow management system 10 of FIG. 1 in accordance with particular embodiments of the present disclosure. According to one embodiment, method 200 may begin at step 202. As noted above, teachings of the present disclosure may be implemented in a variety of configurations of system 10. As such, the preferred initialization point for method 200 and the order of the steps 202-220 comprising method 200 may depend on the implementation chosen.

At step 202, a client 20 may select one or more items (e.g., financial products) to be fulfilled. For example, a customer or sales representative may enter information into a computing device communicatively coupled to workflow manager 50 regarding one or more desired items to be fulfilled.

At step 204, workflow manager 50 may display or caused to be displayed to client 20 information related to a request 28 for the one or more desired items based on at least one of item attributes 26 and customer information 66. For example, based on the desired item(s) and item attributes 26 of such item(s), workflow manager 50 may display (or cause to be displayed) a form or other query indicating information that is to be provided by client 20 in order for the fulfillment process to begin. As another example, workflow manager 50 may display (or cause to be displayed) information regarding a customer desiring to acquire the item(s) (e.g., a form displayed to client 20 may be pre-populated with customer information).

At step 206, client 20 may complete a request 28 (e.g., by inputting information related to the item(s) into electronic forms or in response to queries) and transmit request 28. At step 208, workflow manager 50 may receive request 28. Workflow manager 50 may perform data and field validation as client 20 completes the request, to ensure errors and/or missing required data components are identified prior to submission.

At step 210, workflow manager 50 may generate one or more batches 22 of work units related to received request 28 based on item attributes 26. As discussed above, work units 24 may comprise individual tasks that are to be completed in order to fulfill a request 28 for a particular item. In some embodiments, item attributes 26 may include business rules to be applied in order to fulfill a request 28 for a particular item. For example, if the request is for a loan, item attributes 26 may include business rules that indicate a credit check for the applicant is to be obtained in order to fulfill the loan. Accordingly, a work unit 24 may include the task of obtaining a credit check.

At step 212, workflow manager 50 may select one or more agents 42 to process batch(es) 22 related to request 28 based on at least one of item attributes 26, agent attributes 46, and customer information 66. For example, workflow manager 50 may select an agent 42 based on agent attributes 46 indicating a skill level of an agent 42 and/or a line of business for an agent 42 (e.g., some agents 42 may process requests 28 for loans while other agents 42 may process request 28 for deposit accounts). As another example, agent attributes 46 may indicate an affinity and/or experience of an agent 42 to a particular customer, and such affinity and/or experience may also be used to select an agent 42.

At step 214, workflow manager 50 may transmit batch(es) 22 to selected agent(s) 42.

At step 216, workflow manager 50 may display (or caused to be displayed) to agent(s) 42 information related to the transmitted batch(es) 22, including work units 24 making up such batch(es) 22. For example, workflow manager 50 may display to an agent 42 a list of batches 22 and/or work units 24 that have been assigned or transmitted to the agent 42. Such information may be displayed in any suitable manner. For example, an agent 42 may, via a user interface, filter or arrange the information displayed based on one or more of batch 22 (e.g., displaying work units for a particular batch 22), request 28, an item type (e.g., deposit product or loan product), customer, work unit priority, work unit deadline, and any other suitable factor. In some embodiments, workflow manager 50 may display to an agent 42 batches 22 and/or work units 24 assigned to other agents 42, to facilitate coordination of efforts and/or customer communication.

At step 218, agent(s) 42 may process work units 24. After all work units 24 related to a request have been completed, request 28 may be fulfilled at step 220. After completion of step 220, method 200 may end.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order. In addition, the steps comprising method 200 may be repeated, independently and/or collectively, as often as desired or required by a chosen implementation.

Method 200 may be implemented using system 10 or any other system operable to implement method 200. In certain embodiments, method 200 may be implemented partially or fully in software and/or firmware embodied in computer-readable media.

Based on the foregoing operations, system 10 may optimize workflow of fulfillment of items subject to requests 28. For example, system 10 may ensure that client 20 enters complete and accurate information regarding a customer and/or a requested item, thus potentially reducing the likelihood that an agent 42 will need to obtain more information and/or clarify information provided within a request 28 in order to fulfill an item. As a result, system 10 provides numerous operational benefits. Nevertheless, particular embodiments of system 10 may provide some, none, all, or additional operational benefits.

Modifications, additions, or omissions may be made to system 10 without departing from the scope of the present disclosure. For example, when a component of system 10 determines information, the component may determine the information locally or may receive the information from a remote location. As another example, in the illustrated embodiment, clients 20, agents 42, and workflow manager 50 are represented as different components of system 10. However, the functions of clients 20, agents 42, and workflow manager 50 may be performed by any suitable combination of one or more servers or other components at one or more locations. In the embodiment where the various components are servers, the servers may be public or private servers, and each server may be a virtual or physical server. The server may include one or more servers at the same or at remote locations. Also, workflow manager 50 may include any suitable component that functions as a server. Additionally, system 10 may include any number of clients 20, agents 42, and workflow managers 50. Any suitable logic may perform the functions of system 10 and the components within system 10.

What is claimed is:

1. An apparatus, comprising:
a network interface operable to receive from a client a request to be fulfilled; and
a processor coupled to the network interface, the processor operable to:
determine one or more item attributes associated with the request;
generate a batch of work units related to the request based at least in part on the one or more item attributes;
select an agent from a plurality of agents to process the batch; and
transmit the batch to the agent.

2. An apparatus according to claim 1, the processor further operable to select the agent based at least in part on the one or more item attributes.

3. An apparatus according to claim 1, the processor further operable to:
determine one or more agent attributes associated with the plurality of agents; and
select the agent based at least in part on the one or more agent attributes.

4. An apparatus according to claim 1, the processor further operable to:
determine customer information associated with the request; and
select the agent based at least in part on the one or more agent attributes.

5. An apparatus according to claim 1, the processor further operable to display to the client information to the client associated with the request based at least in part on the one or more item attributes.

6. An apparatus according to claim 5, wherein displaying information to the client comprises at least one of:
displaying an electronic form to the client indicating information incident to fulfilling the request; and
displaying a query to the client indicating information incident to fulfilling the request.

7. An apparatus according to claim 5, the processor further operable to determine customer information associated with the request, wherein displaying information to the client comprises displaying information to the client based at least in part on the customer information.

8. A tangible computer readable medium comprising logic, the logic operable, when executed on a processor, to:
receive a request to be fulfilled from a client;
determine one or more item attributes associated with the request;
generate a batch of work units related to the request based at least in part on the one or more item attributes;
select an agent from a plurality of agents to process the batch; and
transmit the batch to the agent.

9. A tangible computer readable medium according to claim 8, the logic further operable to select the agent based at least in part on the one or more item attributes.

10. A tangible computer readable medium according to claim 8, the logic further operable to:
determine one or more agent attributes associated with the plurality of agents; and
select the agent based at least in part on the one or more agent attributes.

11. A tangible computer readable medium according to claim 8, the logic further operable to:
determine customer information associated with the request; and
select the agent based at least in part on the one or more agent attributes.

12. A tangible computer readable medium according to claim 8, the logic further operable to display information to the client associated with the request based at least in part on the one or more item attributes.

13. A tangible computer readable medium according to claim 12, wherein displaying information to the client comprises at least one of:
displaying an electronic form to the client indicating information incident to fulfilling the request; and
displaying a query to the client indicating information incident to fulfilling the request.

14. A tangible computer readable medium according to claim 12, the logic further operable to determine customer information associated with the request and wherein displaying information to the client comprises displaying information to the client based at least in part on the customer information.

15. A method, comprising:
receiving a request to be fulfilled from a client;
determining one or more item attributes associated with the request;
generating a batch of work units related to the request based at least in part on the one or more item attributes;
selecting an agent from a plurality of agents to process the batch; and
transmitting the batch to the agent.

16. A method according to claim 15, further comprising selecting the agent based at least in part on the one or more item attributes.

17. A method according to claim 15, further comprising:
determining one or more agent attributes associated with the plurality of agents; and
selecting the agent based at least in part on the one or more agent attributes.

18. A method according to claim 15, further comprising:
determining customer information associated with the request; and
selecting the agent based at least in part on the one or more agent attributes.

19. A method according to claim 15, further comprising displaying information to the client associated with the request based at least in part on the one or more item attributes.

20. A method according to claim 19, wherein displaying information to the client comprises at least one of:
displaying an electronic form to the client indicating information incident to fulfilling the request; and
displaying a query to the client indicating information incident to fulfilling the request.

21. A method according to claim 19, further comprising determining customer information associated with the request and wherein displaying information to the client comprises displaying information to the client based at least in part on the customer information.
